(19) United States
(12) Patent Application Publication
(10) Pub. No.: US 2024/0217140 A1
(43) Pub. Date: Jul. 4, 2024

(54) METHOD FOR REMOVING ADHERENT OR IMMIGRATED OLFACTORY SUBSTANCES FROM THERMOPLASTIC PARTICLES AND TREATMENT DEVICE THEREFOR

(71) Applicant: Kreyenborg GmbH & Co. KG, Senden (DE)

(72) Inventors: Jan Hendrik OSTGATHE, Marl (DE); Markus Vogt, Muenster (DE)

(73) Assignee: Kreyenborg GmbH & Co. KG, Senden (DE)

(21) Appl. No.: 18/605,814

(22) Filed: Mar. 14, 2024

Related U.S. Application Data
(63) Continuation of application No. PCT/DE2022/100655, filed on Sep. 5, 2022.

(30) Foreign Application Priority Data
Sep. 15, 2021 (DE) 10 2021 123 837.4

(51) Int. Cl. B29B 13/06; B29K 105/00; F26B 17/22; F26B 17/32; F26B 21/14; F26B 23/04

(52) U.S. Cl. CPC B29B 13/065; F26B 17/22; F26B 17/32; F26B 21/14; F26B 23/04; B29K 2105/251

(57) ABSTRACT

A method for removing adherent or immigrated olfactory substances from thermoplastic particles which take the form of bulk material and are exposed to dry, warm air in a treatment chamber of a warm-air container during a time period. Before the treatment in the warm-air container, the plastic particles are warmed in at least one infrared rotary tube, wherein the infrared rotary tube has at least one infrared radiator device arranged in a central region of the interior space thereof and directed towards the inner wall of the drum thereof. During a time period the plastic particles are warmed while the drum is continuously rotated and after that are transferred in the warm state, with a maximum temperature loss of 20 K, into the treatment chamber of the warm-air container where they continue to be exposed to warm air during the time period.

This nonprovisional application is a continuation of International Application No. PCT/DE2022/100655, which was filed on Sep. 5, 2022, and which claims priority to German Patent Application No. 10 2021 123 837.4, which was filed in Germany on Sep. 15, 2022, and which are both herein incorporated by reference.

### BACKGROUND OF THE INVENTION

### Field of the Invention

The invention relates to a method for removing adherent or immigrated olfactory substances from thermoplastic particles that are present as bulk material and that are acted on by dry, warm, or hot air in a treatment chamber of a warm air container during a time period. The invention further relates to a processing device for same.

### Description of the Background Art

In plastic recycling and also in new goods production, odor-forming substances should be removed from the plastics or reduced to below the threshold of perception. In recycling, odors from the previous use of the material are to be removed. This involves primarily ground-up product of the materials PSPE or PP from, for example, detergent bottles, fuel containers, food packages, or the like. For new goods, there is a requirement, for example in the automotive manufacturing sector, with regard to the lowest possible odor emissions, in particular for use of the plastics in motor vehicle interiors.

The olfactory substances may constitute foreign matter that has adhered from a previous use cycle or immigrated into the plastic matrix, as well as monomers of the plastics and other substituents that remain after manufacture.

Wet cleaning of the plastic particles, which is carried out anyway in the case of recycling, often is not able to remove all odor-forming substances. In addition, mere warming in a warm air container over an extended period does not remove these substances to below the threshold of perception, or the required time frame is too long for economical operation.

A combination of a warm air container with an infrared rotary tube connected upstream is known from DE 103 33 648 A1, which is incorporated herein by reference, by means of which plastic particles from recycled polyester may be dried and crystallized; however, no association with olfactory substances is disclosed.

A processing method for plastic particles containing impurities is known from EP 2 507 022 B2, which corresponds to US 2013/0015604. It is provided to initially subject the plastic to be treated to an extrusion process, and to treat the pellets, thus obtained, with hot air over an extended period. However, densely packed bulk material is not well suited for extensive outgassing of volatile substances, so that the cited document proposes to break up the bulk material using agitators. The extrusion process provided upstream, the very long treatment duration in the hot air container, and the agitators which are necessary in practice result in high energy consumption. In addition, treatment in a warm air container alone is not sufficient. Only a gradual improvement in the odor intensity is achieved. The lack of surface exchange and the low temperature gradient here between the product and the surroundings prevent a satisfactory result.

### SUMMARY OF THE INVENTION

It is therefore an object of the invention to speed up and improve the removal of olfactory substances from plastic particles, at least to the extent that they are no longer perceivable to humans or no longer considered objectionable.

This object is achieved by a method for removing adherent or immigrated olfactory substances in plastic particles, which is based essentially on use of a combination of a warm air container with an infrared rotary tube connected upstream.

A processing device that is suitable for carrying out the method is also provided.

By use of such a combination of a warm air container with an upstream infrared rotary tube according to the invention, odor-forming substances that adhere to plastic particles of all types may be removed more quickly and completely than via mere conditioning in hot air.

The bulk material made up of plastic particles is warmed for a short time period, by means of an infrared rotary tube, to a temperature which in the case of thermoplastics is preferably only a few degrees below the softening temperature of the particular product. This alone results in the removal of many volatile odorous substances, which is facilitated by the continuous circulation of the material in the rotary tube as well as the rapid energy input.

It is also important for the debris bed in the infrared rotary tube to have only a low height and for the entire inner volume of the infrared rotary tube to be free, so that substances that are outgassing even during the pretreatment in the rotary tube may be satisfactorily removed without re-accumulating at some other location.

The plastic may be raised to the desired treatment temperature within a very short time by use of the infrared rotary tube. Due to the infrared radiation that acts on a flat, continuously circulated bed, the heating of the individual particles takes place from the center outward. This results in a partial pressure difference between the interior of the material and the ambient air, which ensures very good transport of the highly volatile odorous substances from the interior to the surface. In addition, the continuous surface exchange due to the movement in the rotary tube during warming facilitates rapid and uniform warming of the product as well as optimal removal of the odorous substances that are already released in this method step. The materials may be treated very quickly and homogeneously, so that each individual particle receives identical treatment. The continuous surface exchange also ensures that the maximum temperature in the material may be brought very close, namely, up to approximately 5 K, to the softening point.

The softening point can be the temperature at which adjacent plastic particles present in the bulk material begin to stick together, i.e., at which agglomerate formation sets in even for a short contact time of a few minutes. According to the invention, the temperature remains just below this threshold or approaches only up to the threshold, so that further conveying of the plastic particles is not a problem and is not hindered by formation of fairly large agglomerates.

Surprisingly, the agglomerate formation may be avoided, even for fairly long conditioning times of up to 1 hour or even greater, provided that a temperature difference of at least 5 K below the above-described temperature threshold for the spontaneous agglomerate formation is maintained.

The absolute softening temperature is dependent on the product to be treated, and therefore must be individually determined.

The product is discharged from the infrared rotary tube and conveyed into a warm air container, in which it is aftertreated with hot air over a period of several hours, with further expulsion of the odorous substances.

The temperature in the warm air container is held slightly below the maximum treatment temperature in the infrared rotary tube. The higher pressure on the material, arising in the warm air container through the product column, is thus compensated for. This is due to the mass, which in the product column within the large-volume container of the warm air container results in compression of the material lying underneath. Local overheating must be avoided.

The processing time in the warm air container is associated essentially with the type of processed material, in particular whether it involves material from material recycling or from the production of new goods, and the intended subsequent use for the material to be treated.

The method may be carried out batchwise or also during continuous operation.

For this purpose, the invention also makes use of the time for the necessary discharge of the bulk material from the warm air container. The conveying device has a casing that is closed at least in part, and extends in any given way from the bottom upwards so that warm air can ascend therein. Since the bulk material in the conveying device is fragmented, whereas previously in the warm air container it was still densely packed, volatile substances that were released due to the prior heat treatment may easily escape from the bulk material during the discharge through the conveying device.

It has been shown here that the discharge operation is particularly advantageous for a period of ≥1 min up to 20 min when at the same time the temperature of the discharged material does not fall below a Δ of 5 K in comparison to the treatment temperature in the warm air container.

A possible design for a continuous operating method provides for heating up the bulk material as it passes through the infrared rotary tube. At that location, within a short time it is warmed to a temperature that is only a few degrees below the softening temperature of the particular plastic. Many volatile substances are already separated in this way. The product is then transferred into a large-volume container for heat aftertreatment with hot air over a period of several hours, for which purpose it is placed, in particular from the top, on the debris bed already present in the container.

From the container, the bulk material may be discharged upwardly in a continuous manner using a vertical screw conveyor, for example, and subjected to further treatment with air, which may additionally contain ozone.

By suitably coordinating the supplied quantity, the rotational speed of the infrared rotary tube, the volume of the treatment chamber, and the discharged quantity, the retention time in the dryer may be controlled in such a way that the supplied quantity per unit time at the entry into the treatment chamber matches the removed quantity per unit time at the exit of the treatment chamber, and at the same time the required treatment times in the first stage in the infrared rotary tube and in the second and third stages in the warm air container are achieved in the same way as with batch operation, and as necessary for the desired degree of reduction of the odors.

Alternatively, the above-described process may be carried out batchwise as a so-called batch process. A suitable processing device for this purpose has approximately the same design as a processing device for a continuous process, but the function sequence is different.

In batch operation, a quantity of bulk material to be treated is first treated in the infrared rotary tube, and is then transferred as a complete portion into the warm air container, and after the treatment in the warm air container is completely removed.

The infrared rotary tube is filled with a fixed quantity of product, and the treatment with infrared radiation is begun. After a fixed treatment time at a temperature that is only a few degrees below the softening temperature of the particular plastic, the infrared rotary tube is completely emptied and the plastic is transferred into a warm air container. At that location it is treated with warm air for a fixed time period, and the odorous substances are further expelled. The warm air container is subsequently emptied, and the plastic is transported away for further treatment or use.

In both method examples it is particularly advantageous when an aftertreatment device is provided which includes a conveying element that begins in the treatment chamber of the warm air container and from there is oriented rising vertically or obliquely from the bottom upwards.

The aftertreatment device may be designed, for example, as a screw conveyor in a vertically oriented screw conveyor tube. By use of this conveying element, not only is the bulk material conveyed from the base region of the treatment chamber to a discharge opening at a higher elevation, but also breaking up and separation of the bulk material during the conveying is achieved. This brings about further aftertreatment, in that hot air once again sweeps over the bulk material that is broken up during the conveying, and volatile substances that have migrated to the exterior of the particles during the long residence time in the treatment chamber are removed. In this preferred method variant, this results in an alternating sequence of treatments as follows: intensive warming in loose, fragmented bulk material in the rotary tube; long-term action by hot air in densely packed bulk material in the treatment chamber of the warm air container; retrieval from the treatment chamber or circulation in loose, fragmented bulk form by means of the aftertreatment device; retrieval over a time period of >1 min with a temperature loss of 5 K in comparison to the treatment temperature in the warm air container; discharge via a conveying element that transports the bulk material in fragmented or loose bulk form, so that volatile substances may escape during the transport.

As a further option, it may also be provided, during the treatment in the warm air container for deodorization, to additionally use ozone for odor reduction. Ozone is already used in various applications for odor removal, for example for odor reduction in exhaust air streams in industrial processes. Ozone has an additional oxygen atom, and therefore is much more reactive than pure atmospheric oxygen, which greatly accelerates the reaction with aromatic hydrocarbons, for example. A further reduction in odor may thus be achieved. Feeding ozone into the process may take place at various locations, alternatively or simultaneously: injection into the cooling air of the infrared lamps in the rotary tube; injection directly into the infrared rotary tube; injection into an air stream of the warm air container; or injection into the optional aftertreatment device.

In addition, the energy balance of the system may be improved by treating the odorous substances in a circulation system. The exhaust air from the infrared rotary tube and/or from the warm air container is conducted by a unit, via either an active filter for the odorous substances, for example activated carbon or potassium permanganate or addition of ozone or irradiation with ultraviolet light, resulting in formation of ozone in the air stream.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of a processing device for carrying out the method in a schematic view;

FIG. 2 shows the curve of the mass temperature T in the bulk material particles as a function of time for tests 1 and 2;

FIG. 3 shows the odor as a function of time for tests 1 and 2 as determined sensorily;

FIG. 4 shows the temperature curve of the bulk material as a function of time for test 3;

FIG. 5 shows the odor as a function of time for test 3 as determined sensorily;

FIG. 6 shows the odor as a function of time for test 4 as determined sensorily;

FIG. 7 shows the temperature curve of the bulk material as a function of time for test 5; and

FIG. 8 shows an example of a processing device for carrying out the method, in a schematic view.

### DETAILED DESCRIPTION

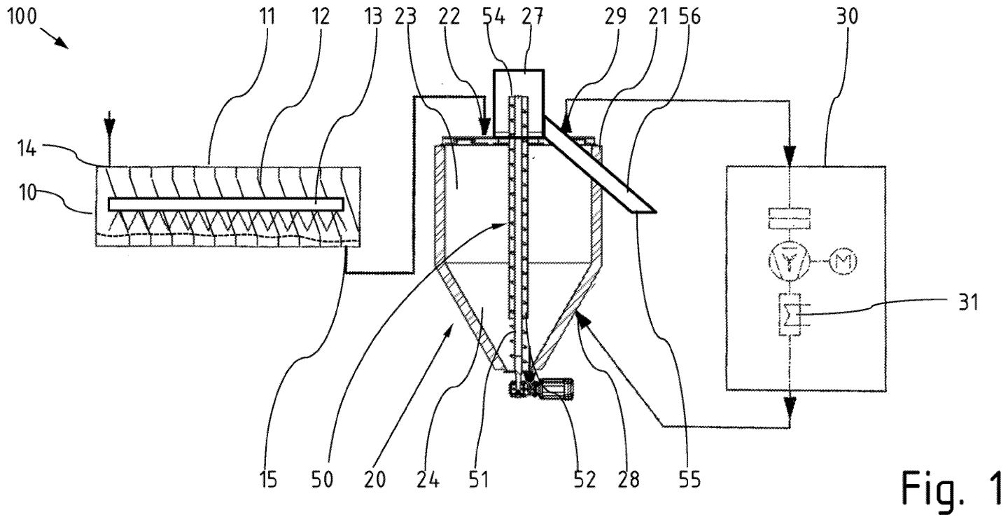

FIG. 1 illustrates a treatment facility 100 for removing adherent or immigrated olfactory substances in plastic particles. This treatment facility essentially comprises a combination of an infrared rotary tube 10 and a downstream warm air container 20, together with an air warming device 30 that is heated via a hot air generator 31.

Plastic particles are supplied to a loading opening 14 at the infrared rotary tube 10. Axial conveying toward a discharge opening 15 takes place via a worm gear having webs 12 at the inner side of the drum 11. An infrared emitter 13 is situated in the free interior space of the drum 11. The infrared radiation emitted from the infrared emitter strikes the bulk material that is spread out in the passages between the worm gear webs 12.

After passing through the infrared rotary tube 10, the preheated bulk material is led via a loading opening 22 into the treatment chamber 23 of a warm air container 20 having insulation 21. At that location the bulk material stays for an extended period that lasts from between the point in time when the bulk material is placed from above on the debris bed present in the treatment chamber 23, to the point in time when the portion in question reaches a feed opening of an aftertreatment device 50 in the base region 24 of the treatment chamber 23.

The aftertreatment device 50 is designed here as a screw conveyor 51 in a vertically oriented screw conveyor tube 52. The screw conveyor tube 52 is open at the bottom, so that bulk material in the region of the lowest point in the base region 24 of the treatment chamber 23 is drawn in by the screw conveyor 51 and conveyed upwardly in the screw conveyor tube 52. At the upper end the screw conveyor tube 52 has an opening aperture 54. From there, the bulk material passes into an intermediate container 27 and slides via a downwardly sloping discharge tube 56 to a discharge opening 56. The treatment process is concluded at the discharge opening 56, so that the bulk material may be packaged or further processed in some other way.

A function of the aftertreatment device 50 is not just to convey the bulk material from the silo-like air container 20. In addition, the invention intentionally provides considerable lengthening of the path the bulk material travels out of the debris bed in the treatment chamber 23. The conveying by the screw conveyor 51 results in intense breaking up of the bulk material in comparison to the densely packed arrangement in the treatment chamber 23. In addition, it is significant that the aftertreatment device 50 specifies a conveying direction that is either vertical or inclined by such an angle with respect to the vertical that a pronounced chimney effect is possible via which volatile substances may be easily withdrawn, for example via collection by filters situated at the end of the conveying distance. When such a vertical or highly inclined orientation is not possible, an angle of the conveying tube of 45° is preferably selected. The breaking up of the bulk material in the screw conveyor 51 together with the warm air that is drawn through ensures that the substances that are removed by the long heat treatment in the previous treatment stages and migrated into layers of the particles near the edge are able to vaporize.

In the opposite direction from the movement of the bulk material in the treatment chamber 23, hot air is introduced at an opening 28 in the lower region of the warm air container 20, and is led through the debris bed in the interior and drawn off at a suction opening 29 at the top side in order to be processed in the air warming device 30 and reheated in the hot air generator 31.

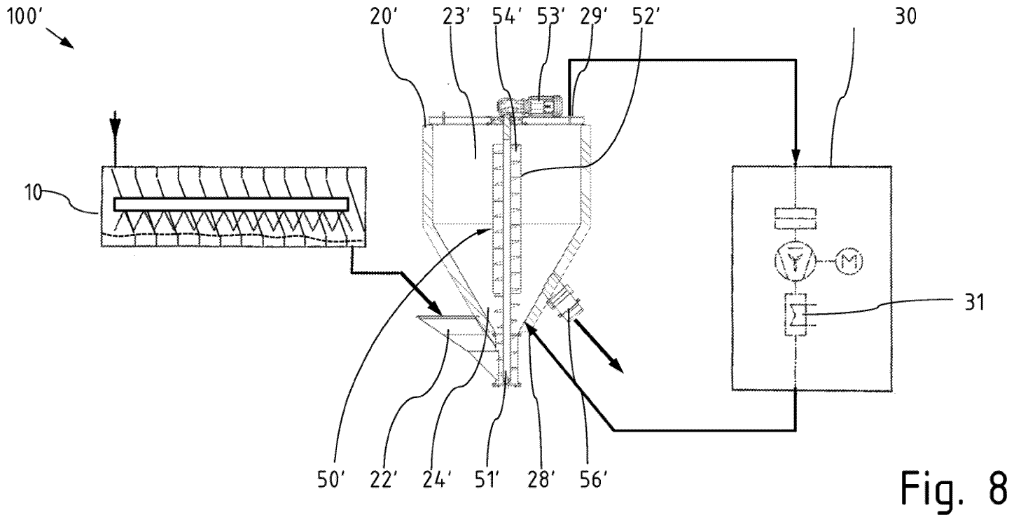

FIG. 8 illustrates a further treatment facility 100′ for removing adherent or immigrated olfactory substances in plastic particles. This treatment facility likewise comprises a combination of the infrared rotary tube 10 and a downstream warm air container 20′ together with an aftertreatment device 50′ and the air warming device 30, which is heated via a hot air generator 31.

The bulk material that is pretreated in the infrared rotary tube 10 is conveyed to a feed device at the warm air container 20′ having a loading opening 22′.

The aftertreatment device 50′ situated in the warm air container 20′ includes a screw conveyor 51′ in a vertically oriented screw conveyor tube 52′, and a motor 53′. The screw conveyor 51′ extends from the loading opening 22′, which is situated beneath the treatment chamber 23′ and separate therefrom, vertically upwardly through the treatment chamber 23′, to an upper opening aperture 54′ situated inside the treatment chamber 23′.

Hot or warm air is heated up in the hot air generator 31 of the air warming device 30, introduced at an opening 28′ into the warm air container 20′, and withdrawn at a suction opening 29′.

The special feature of the warm air container 20′ is that the screw conveyor tube 52′ in the base region 24′ of the lower, cone-shaped portion of the treatment chamber 23′ is partially interrupted. Thus, not only is the bulk material conveyed upwardly from the loading opening 22′ via the rotation of the screw conveyor 51′ during filling of the warm air container 20′, but also bulk material that has already collected in the base region 24′ is drawn back in and once again led up to the opening aperture 54′, from where it drops into the treatment chamber 23′. Thus, the bulk material is not only treated by the warm air that flows through the debris bed in the treatment chamber 23′, but is also drawn in continuously through the screw conveyor 51′ in the screw conveyor tube 52′, circulated, broken up, and highly fragmented so that volatile substances may satisfactorily vaporize.

When the warm air treatment process in the warm air container 20′ has concluded, the bulk material is discharged at a discharge opening 56′ situated above the loading opening 22′ at the warm air container 20′.

Several method examples are described below in which the treatment facility 100 depicted in FIG. 1 has been used in each case. The warm air container 20 that is used is an insulated container having a filling volume of 500 L. A hot air stream flows through the warm air container from the bottom upwards.

After passage through both treatment stages, multiple samples are withdrawn, and after cooling are tested by gas chromatography and by a sensor regarding the volatile organic compounds (VOC), semivolatile organic compounds (SVOC), or odors remaining in the plastic particles.

For example, the following odor-forming chemical substances were identified in the gas chromatographic analysis of polyethylene that was treated according to the invention: Acetone; toluene; xylene; benzophenone; mesitylene; aliphatic hydrocarbons; aromatic hydrocarbons; benzene; and/or limonene

The qualitative odor reduction was also sensorily tested, with selection of the following odor descriptions according to the study by M. Strangl et al., Journal of Cleaner Production: Smoky lemony waxy fatty/rancid musty; and/or soapy/detergent-like

### Test 1: Comparative Test

Treatment of black HDPE granules only in the warm air container without using an upstream infrared rotary tube.

### Test Parameters:

Total product quantity: 216 kg
Bulk density: 0.6 kg/L
Inlet temperature of the warm air container: 115° C.
Softening temperature of the bulk material: approximately 125° C.
Air flow in the warm air container: 300 m³/h
Sampling: every full treatment hour

### Test Steps:

Filling the container at the warm air container (2 min)
Heating up the container volume (150 min)
Removing the bulk material after a total treatment time of 7 h

### Test 2:

Two-stage treatment according to the invention of black HDPE granules.

### Test Parameters:

Total product quantity: 216 kg
Batch size: 36 kg
Bulk density: 0.6 kg/L
Inlet temperature of the warm air container: 115° C.
Softening temperature of the bulk material: approximately 125° C.
Air flow in the warm air container: 300 m³/h
Sampling: directly after a batch and after every full treatment hour

### Test Steps:

Filling the infrared rotary tube (2 min)
Treating the product with infrared radiation (t1=25 min)
Emptying the infrared rotary tube into the secondary container (2 min)
Aftertreatment in the treatment chamber over a time period t2 up to a total treatment time of 6 h at a hot air temperature of 115° C.
Discharging the material over t3=10 min and subsequent sensory testing

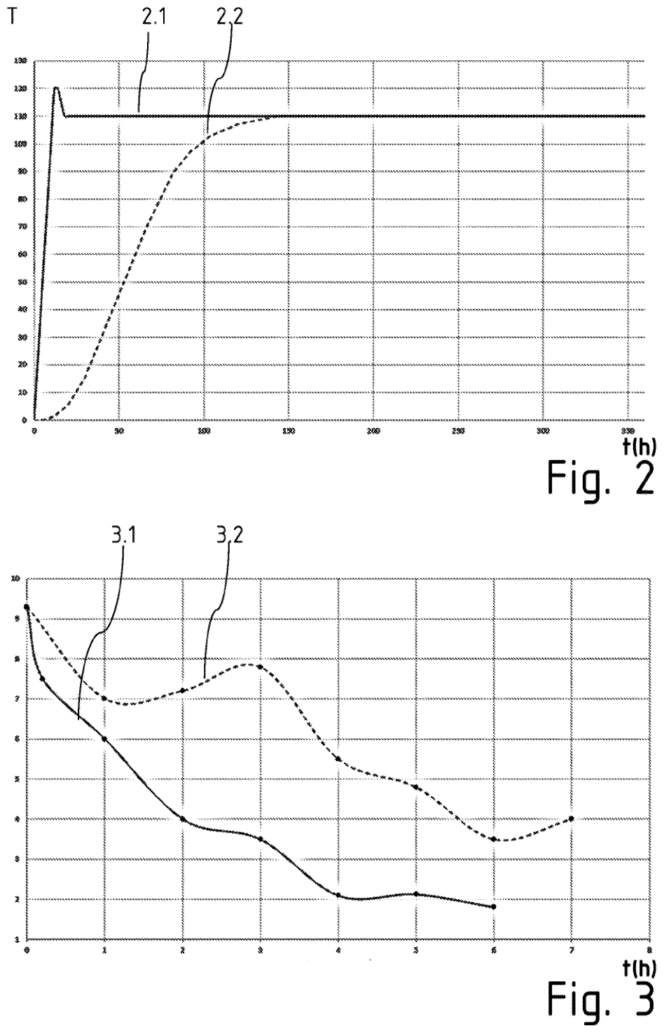

The results of the two tests described above are compared in FIGS. 2 and 3.

FIG. 2 shows the curve of the mass temperature T in the bulk material particles as a function of time t. In the figure, graph 2.1 shows the temperature curve for the two-stage heating using the infrared rotary tube as the first stage according to test 2 and graph 2.2 shows the temperature curve for the comparative test without using an infrared rotary tube.

It is clearly apparent from a comparison of graphs 2.1 and 2.2 that according to the invention, the desired process temperature is reached much more quickly than in the comparative test.

FIG. 3 plots the residual odor, as determined sensorily, as a function of time, and in particular for each of the samples taken hourly. On the sensory scale, 1 corresponds to a barely perceivable odor, and 10 corresponds to a strong odor that is perceived as objectionable. Graph 3.1 depicts the result of the bulk material treated according to the invention, and graph 3.2 depicts the result of the comparative test. Although the treatment times and also the treatment temperatures were in each case the same in the warm air container, the residual odor from the charge treated according to the invention was much lower.

### Test 3:

The test was conducted using new goods made of thermoplastic elastomers (TPE), in particular thermoplastic vulcanizates (TPV), as sealant material in the automotive industry.

### Test Parameters:

Total product quantity: 60 kg
Bulk density: 0.5 kg/L
Batch size: 30 kg
Inlet temperature of the warm air container: 115° C.
Softening temperature of the bulk material: approximately 130° C.
Air flow in the warm air container: 400 m³/h
Sampling: directly after a batch and after every full treatment hour

### Test Steps:

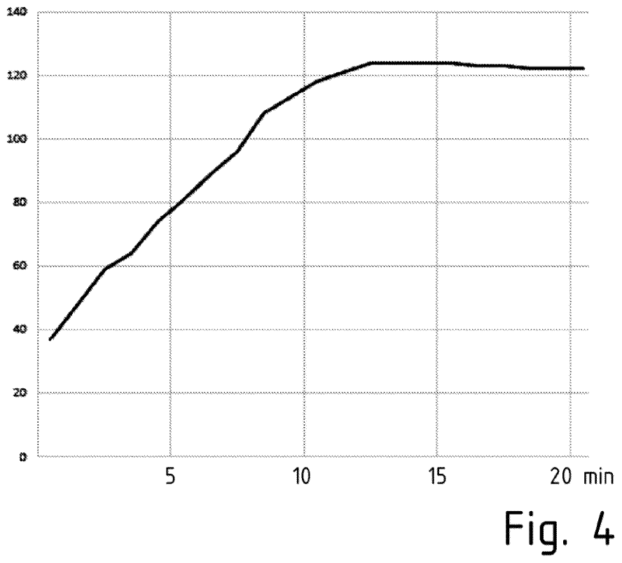

Filling the infrared rotary tube (2 min)
Treating the product with infrared radiation (t1=20 min); see FIG. 4 for temperature curve
Emptying the infrared rotary tube into the preheated secondary container (2 min)
Aftertreatment in the treatment chamber over a time period t2 up to a total treatment time of 4:20 h at a hot air temperature of 120° C.
Discharging the material over t3=10 min and subsequent sensory testing

FIG. 4 shows the temperature curve over the first 20 minutes after placement in the infrared rotary tube.

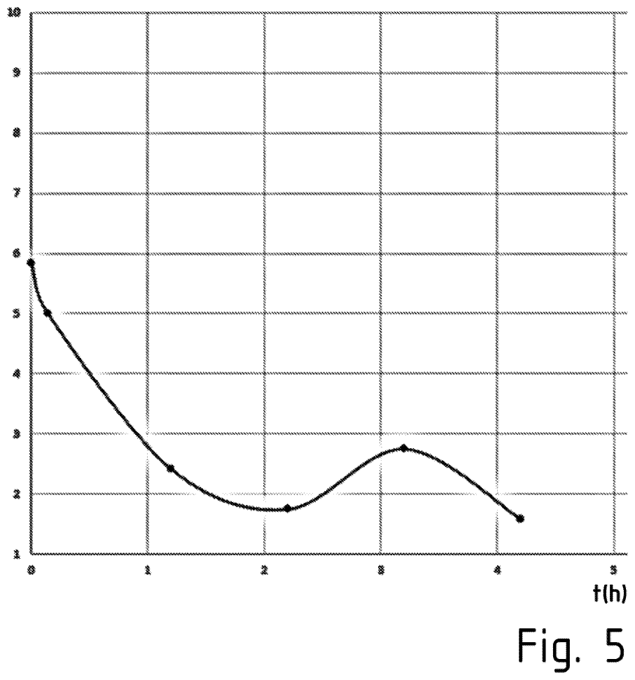

FIG. 5 shows the odor as determined sensorily, as a function of time.

### Test 4

Treatment of colored high-density polyethylene (HDPE) flakes, a dual system product.

### Test Parameters:

Total product quantity: 125 kg
Bulk density: 0.35 kg/L
Batch size: 21 kg
Inlet temperature of the warm air container: 110° C.
Softening temperature of the bulk material: approximately 120° C.
Air flow in the warm air container: 300 m³/h
Sampling: directly after a batch and after every full treatment hour

### Test Steps:

Filling the infrared rotary tube (2 min)
Treating the product with infrared radiation (20 min)
Emptying the infrared rotary tube into the preheated secondary container (2 min)
Aftertreatment in the treatment chamber over a time period t2 up to a total treatment time of 4:20 h at a hot air temperature of 120° C.
Discharging the material over t3=10 min and subsequent sensory testing

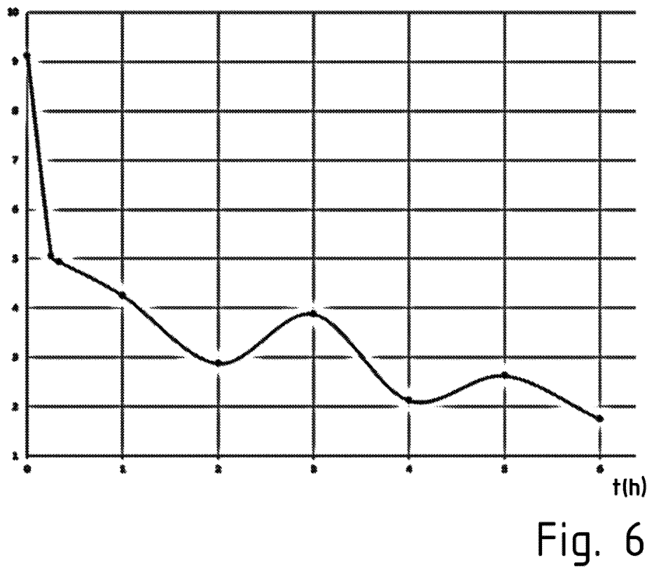

FIG. 6 shows the odor as determined sensorily in this test, as a function of time.

### Test 5

Continuous treatment process for HDPE flakes.

### Test Parameters:

Infrared rotary tube: IRD 180/360
Throughput: 1000 kg/h
Bulk density: 0.33 kg/L
Softening temperature of the material: 125° C.
Volume of the warm air container: 12 m³
Inlet temperature of the warm air container: 115° C.
Air flow in the warm air container: 2500 m³/h

### Test Steps:

Continuously filling the infrared rotary tube
Treating the product with infrared radiation (t1=20 min)
Emptying the infrared rotary tube into the hot air container (continuously while holding the product for at least 4 h)
Aftertreatment in the hot air container up to a total treatment time of 4 h at an inlet air temperature of 115° C.
Discharging the material over t3=15 min for direct further processing.

### Test 6

Treatment of naturally colored/transparent polystyrene (PS), regranulate produced from expanded polystyrene (EPS) from collection systems, two-stage treatment.

### Test Parameters:

Total product quantity: 20 kg
Batch size: 20 kg
Bulk density: 0.45 kg/L
Treatment temperature of the IR batch: 90° C.
Inlet temperature of the warm air container: 85° C.
Air flow in the warm air container: 7 m³/h
Sampling: directly after the treatment in the infrared rotary tube as well as 3, 6, and 8 hours after charging the warm air container

### Test Steps:

1) Filling the infrared rotary tube (2 min)
2) Treating with infrared radiation (20 min)
3) Emptying the infrared rotary tube into the warm air container (2 min)
4) Aftertreatment in the treatment chamber up to a total treatment time of t2=8:20 h at a hot air temperature of 85° C.
5) Discharging the material over t3=5 min and subsequent sensory testing.

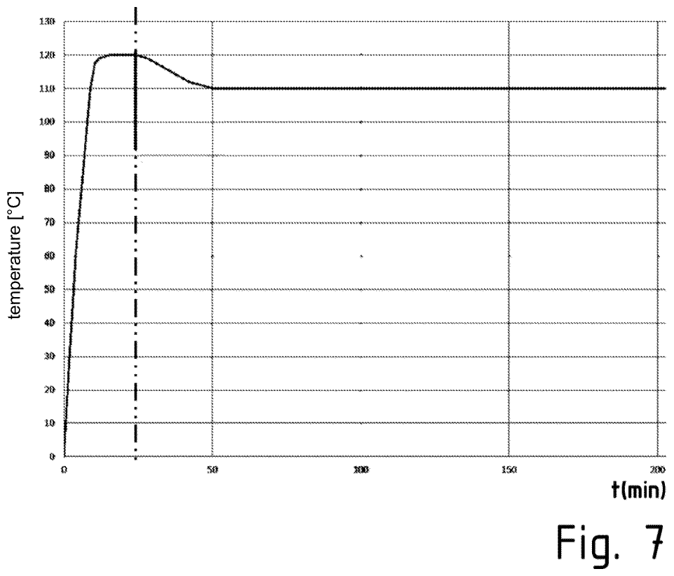

FIG. 7 shows one possible temperature curve over the treatment time in such a continuous process in which the infrared treatment and warm air treatment for HDPE flakes are combined. The dash-dotted line indicates the division into a first phase in the infrared rotary tube 10 and a second phase in the warm air container 20. The temperature was measured at the surface of the particles in the bulk material.

The high heating rate in the first phase is clearly visible. The provided heat-up temperature of 120° C. at the surface was reached in less than one-half the time of the intended time period t1 of 20 min.

During the transfer from the first into the second treatment stage, cooling by 10° C. was provided, and at this reduced temperature of approximately 110° C. the hot air treatment in the warm air container was carried out over an extended period of time.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for removing adherent or immigrated olfactory substances from thermoplastic particles that are present as bulk material and that are acted on by dry, warm air in a treatment chamber of a warm air container during a time period t2, the method comprising:
warming, before the treatment in the warm air container, the plastic particles in at least one infrared rotary tube, the infrared rotary tube having at least one infrared emitter that is arranged in a central region of the interior space thereof and directed toward an inner wall of the drum thereof;
rotating continuously the drum, during a time period t1, while the plastic particles are warmed, and subsequently transferring the plastic particles in the warm state, with a maximum temperature loss of 20 K, into the treatment chamber of the warm air container, where the plastic particles continue to be acted on by warm air during the time period t2; and
aftertreating over a third time period t3, after the treatment in the warm air container, the bulk material in a conveying device that extends from the bottom upwards; and
discharging the bulk material.

2. The method according to claim 1, wherein the bulk material is conveyed by the conveying device from a base region of the treatment chamber in the warm air container to a discharge opening, and wherein the conveying device is vertical or inclined by an angle with respect to the vertical and is separated from the treatment chamber by at least one closed wall.

3. The method according to claim 2, wherein the bulk material is conveyed upwardly, by a screw conveyor that rotates in a screw conveyor tube, from a base region of the treatment chamber to an opening aperture of the conveying device at a higher elevation.

4. The method according to claim 3, wherein the bulk material is conveyed at a slope from the opening aperture of the conveying device to a discharge opening at a lower elevation.

5. The method according to claim 2, wherein the bulk material is continuously discharged from the discharge opening into the warm air container by the conveying device.

6. The method according to claim 1, wherein the plastic particles in the infrared rotary tube and/or in the warm air container are warmed to a temperature that is 10 K to 5 K below the softening temperature.

7. The method according to claim 1, wherein the bulk material is acted on by ozone during the transfer from the infrared rotary tube and/or in the warm air container.

8. The method according to claim 1, wherein the bulk material is made up of plastic particles composed of polystyrene, polyolefins, and/or thermoplastic elastomers.

9. A processing device to carry out the method according to claim 1, the processing device comprising:
an infrared rotary tube, which in a central region of its interior has at least one infrared emitter directed towards the inner wall of the drum thereof;
a transfer device for transferring the bulk material from the infrared rotary tube into a warm air container, the warm air container with a silo housing with at least one inner treatment chamber has a loading opening and a discharge opening;
an air warming device that conveys warm air into the treatment chamber and withdraws it therefrom; and
a conveying device used as an aftertreatment device extends upwardly from the treatment chamber.

10. The processing device according to claim 9, wherein the conveying device includes an upwardly conveying screw conveyor that is situated in a screw conveyor tube, in which at least one feed opening is situated in a funnel-shaped base region of the treatment chamber, and at least one opening aperture in the screw conveyor tube is provided above the feed opening.

11. The processing device according to claim 10, wherein a discharge tube extending at a slope from the opening aperture to the discharge opening in the warm air container adjoins the opening aperture.

12. The processing device according to claim 10, wherein the screw conveyor tube is arranged vertically or inclined by an angle of less than 45° with respect to the vertical, and over at least a portion of its length extends through the treatment chamber.

13. The processing device according to claim 9, wherein the inner wall of the drum is provided with at least one worm gear web.
